(19) United States
(12) Patent Application Publication
(10) Pub. No.: US 2004/0003074 A1
(43) Pub. Date: Jan. 1, 2004

(54) Application server functions

(76) Inventor: Giacomo Piccinelli, Bristol (FR)

Correspondence Address: HEWLETT-PACKARD COMPANY, Intellectual Property Administration, P.O. Box 272400, Fort Collins, CO, 80527-2400, US

(21) Appl. No.: 10/387,701

(22) Filed: Mar. 12, 2003

(30) Foreign Application Priority Data
Mar. 13, 2002 (GB) 0205841.0

(51) Int. Cl. G06F 15/173

(52) U.S. Cl. 709/223

(57) ABSTRACT

The invention proposes the inclusion of process management capabilities 16 as an internal service to the applications run on an application server 28 and the components deployed into the application server 28.

### FIELD OF THE INVENTION

This invention relates to the provision of application server functions and to an application server having specified functions.

### DESCRIPTION OF RELATED PRIOR ART

In the field of electronic services (e-services), particularly those provided over the internet, business assets and services are available for purchase. E-services can be offered and bought in an e-market place, which can be involved in all stages of the life cycle of a transaction. An e-market place infrastructure should provide the support services and tools required for the provision of e-services, from their advertising, through to their negotiation and their actual delivery.

A typical e-market place has a structure as shown in FIG. 1, in which lower layers (communication layer 10 and execution layer 12) provide the standard execution environment for an e-commerce system. The execution layer 12 includes an application server 28, a data repository 29 and a security manager 30. A service management layer 14 provides advanced access services and process management facilities 16. In particular, it provides a cluster of web facing services 18 together with functions for membership management (e.g. authentication and profiling) and service-session management. Process management provides the foundation for electronic management of contractual agreements. A solution management layer 20 provides the core facilities for second generation e-market places, namely service composition 22, negotiation support 24 and contract management 26. The service composition engine 22 defines the requirements for service providers needed to support a specific service request. Requirements are in terms of operational capabilities, as well as service delivery processes. The negotiation engine 24 deals with classic auction-based price optimisation, as well as complex contractual issues (namely service delivery process). The contract manager 26 provides monitoring and execution support for electronic contracts. The focus of the contract manager 26 is on the business interaction that derives from the contractual agreement.

A problem with the prior art set up described in relation to FIG. 1 has been identified in that there is a gap between the services offered in the application server 28 (such as transaction management, persistence management, load balancing and similar features) and the process management possible in the service management layer 14 of FIG. 1. The gap between the application server 28 and process management systems 16 becomes more noticeable when code written for the process management part of the e-market place is not included in an application server of that e-market place.

In an existing configuration an application server 28 would offer services to a user in the process of writing computer programs. Such services may be to allow the user to subscribe to a replication service, to allow access to databases controlled by the application server 28 or to provide security access.

### SUMMARY OF THE INVENTION

According to a first aspect of the present invention a computing platform comprises at least a communication layer and an execution layer, wherein the execution layer includes at least an application server and a process management section having process management capabilities.

The process management section may be a process management server. The process management capabilities may include the management of contractual agreements.

The provision of process management capabilities in the execution layer advantageously allows for the integration of the higher level action of process management capabilities with the lower level execution level services, such as transaction management, load balancing and persistence management. The services offered by process management capabilities, such as data input operations, saving to disc operations, graphical display and printing operations are advantageously managed by the process management capabilities. The standard application server capabilities of isolating business logic from platform related code are advantageously augmented by process management capabilities.

The process management section is preferably operable to manage connections between other services on the application server or in the execution layer.

The process management section preferably dynamically interacts with other components on the application server or in the execution layer.

The process management section preferably incorporates process management capabilities as an internal service to applications and/or components deployed in the application server.

The communication layer may permit communication of the computing platform with an intranet or internet. The execution layer may include a data repository and/or may include security management capabilities, which may be a part of the application server.

The computing platform may additionally include a service management layer. The computing platform may include a solution management layer, which may include a service composition engine, a negotiation engine and/or a contract manager.

The computing platform may provide an electronic market place.

The invention extends to an execution layer of a computing platform as described in the first aspect.

According to a second aspect of the invention a computer application server incorporates a process management section having process management capabilities as an internal component of the computer application server.

According to a third aspect of the present invention an application server environment of a computing platform incorporates a process management section having process management capabilities.

The process management section is preferably an internal component of the application server environment.

All of the features described herein may be combined with any of the above aspects, in any combination.

### BRIEF DESCRIPTION OF THE DRAWINGS

For a better understanding of the invention and to show how the same may be brought into effect specific embodiments of the invention will now be described, by way of example, and with reference to the accompanying drawings in which:

FIG. 1 is a schematic diagram showing the components of an existing e-market place; and

FIG. 2 is a schematic diagram of an application server having process management capabilities.

### DESCRIPTION OF PREFERRED EMBODIMENTS

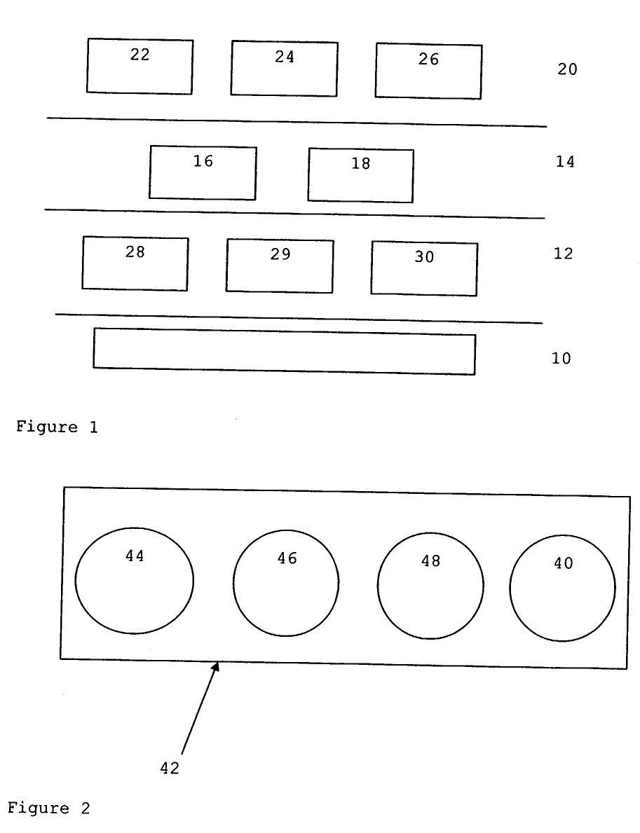

As described in relation to FIG. 1 a prior art e-market place set up would involve a standard execution environment 12 including an application server 28, such as the Java 2 Enterprise Edition (J2EE) server or a BlueStone application server (a Hewlett-Packard product). The services available in the application server include a subscription to a replication service, access to databases or security access control, transaction management, persistence management and load balancing. More information can be found in the J2EE tutorial available from Sun Microsystems, the contents of which are incorporated herein by reference.

Process management capabilities 16, such as those provided by the Hewlett-Packard Process Manager product (see www.ice.hp.com for more information—that information being incorporated by reference) are not available as an internal service to the application server 28. Process management is discussed in the eAI Journal, March 2001 issue in the article “Out of the Alligator Pool: A Service-Oriented Approach to Application Development” by Elizabeth Ward and Eric Stammers. That document is incorporated herein by reference.

In prior art systems process management capabilities 16 are only offered in a higher service management layer 14, as shown in FIG. 1.

In order to integrate process management capabilities with the application server environment services manual action would have been needed in the set up shown in FIG. 1.

The present invention proposes the inclusion of process management capabilities 16 as an internal service to the applications run on the application server 28 and the components deployed into the application server.

FIG. 2 shows a schematic diagram having process management capabilities 40 within an application server environment 42. Security access 44, database access 46 and transaction management 48 are also shown within the application server environment.

In an application server 42 most activity is taken up by interaction between programs. At present, interactions between those programs must be integrated manually. By provision of process management facilities within the application server 42 dynamic interaction of the existing components on an application server 42 can be achieved. Dynamic interaction with the process management facilities 40 is also achieved. Thus, the connections between existing services running on the application server 42 are made considerably more efficient.

At the level of composing the code for running on the application server 42 the facility to allow process management is also a significant advantage. Writing pieces of computer code for interacting programs is made considerably easier with the Hewlett-Packard product Process Manager installed in the application server environment, for example components for graphical display, printing, inputting of fields, and save to disc operations can all be made to interact in a very efficient manner by using the process management facilities. The provision of this service within the application server environment has significant advantages over the previous e-market place structure in which process management facilities were on a different level of the structure to the application server environment, and thus required manual integration with application server services.

As discussed above, the use of the Hewlett-Packard Process Manager allows the integration of existing services and also allows uniform interfaces to be provided more easily. In addition, the ability to orchestrate processes is provided and features such as statistics on the various processes which are integrated can be provided which would previously not have been possible without the process management facilities incorporated into the application server.

1. A computing platform comprises at least a communication layer and an execution layer, wherein the execution layer includes at least an application server and a process management section having process management capabilities.

2. A computing platform as claimed in claim 1, in which the process management section is a process management server.

3. A computing platform as claimed in claim 1, in which the process management section is operable to manage connections between other services on the application server or in the execution layer.

4. A computing platform as claimed in claim 1, in which the process management section dynamically interacts with other components on the application server or in the execution layer.

5. A computing platform as claimed in claim 1, in which the process management section incorporates process management capabilities as an internal service to applications and/or components deployed in the application server.

6. A computing platform as claimed in claim 1, in which the communication layer permits the communication of the computing platform with an intranet or internet.

7. A computing platform as claimed in claim 1, in which the execution layer includes a data repository and/or security management capabilities, which are a part of the application server.

8. A computing platform as claimed in claim 1, which may additionally include a service management layer.

9. A computing platform as claimed in claim 1, which provides an electronic market place.

10. An execution layer of a computing platform as claimed in claim 1.

11. A computer application server incorporates a process management section having process management capabilities as an internal component of the computer application server.

12. An application server environment of a computing platform incorporates a process management section having process management capabilities.

13. An application server environment as claimed in claim 12, in which the process management section is an internal component of the application server environment.
